(19) United States
(12) Patent Application Publication
(10) Pub. No.: US 2010/0226468 A1
(43) Pub. Date: Sep. 9, 2010

(54) METHOD FOR DETERMINING AN UNCERTAINTY COMPONENT RELATING TO POWER DISTRIBUTION IN A NUCLEAR REACTOR CORE

(76) Inventor: Gérard Rio, Saint Germain en Laye (FR)

Correspondence Address: Pearl Cohen Zedek Latzer, LLP, 1500 Broadway, 12th Floor, New York, NY, 10036, US

(21) Appl. No.: 12/663,578

(22) PCT Filed: Jun. 5, 2008
(86) PCT No.: PCT/FR08/51001

§ 371 Date: Apr. 19, 2010

(30) Foreign Application Priority Data
Jun. 8, 2007 (FR) 0755584

(51) Int. Cl. G21C 17/00

(52) U.S. Cl. 376/245

(57) ABSTRACT

The invention relates to a method for obtaining (206) an error propagation uncertainty component (R_{U}^{N}₂ₚ) for any nuclear reactor including reactors intended to be provided with a measurement instrumentation system for which there is no operation feedback concerning the system in question For this purpose, the invention comprises the use of data (200) originating from experience feedback acquired with a reference instrumentation system, e.g. the core instrumentation reactor system The experience feedback is used to apply disturbances to a theoretical power distribution model (201), the spatial distribution and amplitude of said disturbances being such that the deviations observed (203) between the disturbed theoretical model and the theoretical model resulting directly from the calculation are representative of those observed in reality.

### TECHNICAL FIELD OF THE INVENTION

The invention relates to a method for determining an uncertainty component relating to the power distribution of a nuclear reactor core. The uncertainty component determined by the method according to the invention is one of the components of a total uncertainty, referred to as uncertainty E_{U}^{N}, entering into a general method of reconstruction of a power distribution determined for each operational state of a nuclear reactor.

The field of the invention is generally that of nuclear reactors. Nuclear reactors, such as pressurised water-cooled nuclear reactors, comprise a core constituted by fuel assemblies, each assembly comprising a plurality of fuel rods, in particular of uranium slightly enriched with isotope 235; the assemblies are disposed juxtaposed with their longitudinal axes in the vertical direction, i.e. following the height of the core.

In the rest of the document, the longitudinal axes are therefore generally denoted by dimension z, abscissas x and ordinates y permitting the determination of a point, of the nuclear reactor in a horizontal plane. It can thus be considered that a nuclear reactor core is cut up into slices, or axial sections, of a certain thickness, denoted by height z; a point of a nuclear reactor is identified moreover by its azimuthal position, on the basis of an angle defined in a horizontal plane, in relation to the z axis of the dimensions of the orthogonal three-dimensional reference system (x,y,z), and by its radial position, defined by a distance in a horizontal plane between the point in question and the axis of the dimensions.

The power released by the assemblies, a power directly correlated with the neutron flux generated by the fuel present in said assemblies, is not distributed uniformly inside the volume of the reactor. There are points where the power is higher than at others, typically at the centre of the reactor compared to the periphery. One then speaks of hot spots; it is at these points that the supplied power approaches most closely the design limits of the nuclear reactor core. Consequently, the power distribution in a nuclear reactor core is not homogeneous; the preparation of a complete power map in the core, referred to as a 3D power distribution, which is a fundamental operation for obvious safety reasons, is therefore a complex operation.

Thus, the operation and safeguarding of nuclear reactors necessitates the determination of the energy supplied by fissions of the nuclei of uranium 235, i.e. the nuclear power, at each point of the nuclear reactor. For this purpose, measurements are carried out to evaluate the power at different points of the nuclear core. In all cases, the evaluation of this power involves measurements of the radiation emitted by the reactor core, and more particularly the neutron flux.

The measurement of a neutron flux always involves a neutron/matter interaction which creates particles capable of producing a measurable electric current. After each absorption of a neutron, the atoms of the sensitive matter constituting the sensor are transformed; the sensitive matter as such therefore gradually disappears. This disappearance takes place at a rate which is a function of the intensity of the neutron flux and the probability of occurrence of the reaction, itself directly linked to the effective absorption cross-section. The higher this probability and the stronger the current supplied, the more rapidly, on the other hand, the sensitive matter disappears, which then very quickly necessitates replacement of the sensor.

The problem of the depletion of the sensitive matter thus crucially arises for a neutron sensor permanently located inside the core.

In order to respond to this sensitive problem of depletion of the sensors, numerous nuclear reactor designers have chosen not to leave the sensors standing in the measurement position in the core, and to send the latter into the reactor solely to take readings intermittently. Conventionally used sensors are therefore referred to by the term “mobile internal instrumentation”, which in the rest of the description will be referred to as an RIC system (Reactor Instrumentation Core). The function of the RIC system is to measure precisely the flux distribution in the reactor core, with relatively minor constraints in terms of response time.

In practice, the RIC system also coexists with a control system known as an RPN (nuclear reactor protection) system, disposed outside the nuclear reactor core and responsible for measuring several parameters of the power distribution (such as axial and azimuthal disequilibria) and the power level, with a very good response time, but a lesser degree of precision of the measurements than the RIC system. The RPN system is periodically calibrated, because the proportionality between the external measurement and the actual power level of the reactor depends on the radial component of the power distribution, which itself varies with the depletion of the fuel. The data provided by the RIC system can be used to perform such a calibration.

More generally, the RIC system is used in two well-defined circumstances:

In the first place, during start-up test periods or after each reloading of the assemblies, or in individual test periods, the RIC system is used to:
verify that the power distribution at the start of a cycle is in accordance with the design calculations and in particular that the value of the hot spots complies with the design assumptions;
calibrate the detectors of the RPN system;
detect any loading error;
supply data on the distribution of fluxes which participate in the qualification of data-processing codes and methods used in the design calculations for the reactor core.

Next, during a cycle and during normal operation, the RIC system is used in particular to:
verify that the power distribution, and in particular the hot spot factors, evolve as a function of time as has been provided for them in the design calculations;
verify and/or calibrate the detectors of the RPN system.

In terms of precision, a compromise has conventionally been chosen between the desire to measure the power in a large number of assemblies, and a practical reality consisting in the fact that it is necessary, for each instrumented position, to make a hole in the bottom of the vessel of the nuclear reactor. This compromise results in the penalising fact that a limited number of instrumented assemblies has been selected, a solution which is advantageous economically and technologically, but which consequently limits the precision of the flux distribution measurement and which necessitates the existence of a margin, given by an uncertainty calculation detailed below, in order to cover imperfect experimental knowledge of the 3D power distribution, in particular at the hot spots.

In practice, use is made of six mobile neutron detectors. The mobile detectors are of the fission chamber type. This type of neutron sensor comprises a conventional ionisation chamber and employs uranium as neutron-sensitive matter. The current supplied by the mobile detectors is proportional to the fission reaction rate in the detector and not directly to the power; one often therefore preferably speaks of activity and not of power; a phase for the transposition of the activity measurements to a power determination is subsequently introduced in the evaluation of the measurements carried out. This transposition gives rise to a particular uncertainty component, denoted 4.

The mobile detectors are sent by a switching device into tight tubes called glove fingers, placed in an instrumentation tube of 60 fuel assemblies selected for this purpose. The selected fuel assemblies are called instrumented assemblies. Thus, each detector is intended to explore ten assemblies. Mechanisms bring group selectors into play in order to ensure the transfer of the detectors from one assembly to the other.

It can be stated here that the acquisition process comprises one or more additional so-called intercalibration passes.

The quantity of sensitive matter subjected to the interaction with the neutrons in fact diminishes with the duration of irradiation of the detector and more precisely the fluence received by the latter. The sensitivity, i.e. the ratio between the current emitted and the flux experienced by the detector, changes over time: a correction is therefore necessary in the evaluation in order to take account of this variation. Each mobile probe evolves differently from the others, since it receives a fluence which is particular to it, a function of the power of the assemblies that it is exploring. The function of the intercalibration passes, therefore, is to permit the measurement of the relative sensitivities. The determination of the sensitivities must be carried out before each complete flux map and it is compulsory. Thus, the calibration of the detectors is an operation which consists in acting on the electrical gain of the measurement chain in order to compensate for the reduction in current supplied by the sensor with depletion and to keep the indicated value constant. This operation also makes it possible to correct the differences between detectors that may appear due to the fact that each of them has its own electronic acquisition system. In practice, it is carried out in the following manner:

All the group selectors are orientated towards a so-called standby position, which permits each of the probes to explore the assemblies normally measured by the probe of the row directly above (except for probe 6 which, by circular permutation, explores the assemblies normally allocated to probe 1). It is thus possible to compare the measurements obtained during the intercalibration passes in order to determine the relative sensitivities of the probes, and to take account thereof in the evaluation of the measurements.

Flux map is the name given to the result of the evaluation of the measurements carried out by the mobile internal instrumentation system during the examination of the 60 assemblies selected for this purpose, i.e. a partial distribution of the reaction rate in three dimensions on the core determined by the measurements carried out.

Thus, although it measures the flux distribution is a significant number of fuel assemblies −30% approx. of the assemblies are instrumented—the RIC system does not cover the whole core radially. If the hot spot factor is located in a non-instrumented assembly, it escapes the measurement. It is therefore necessary to supplement the information supplied by the mobile detectors. The additional information is provided by theoretical calculation. The establishment, of a 3D power distribution of a nuclear reactor core, detailed below, thus always calls for a combination of experimental data and calculated data.

Instrumentation systems other than the RIC can equip industrial reactors. For example, mention may be made here of the Aeroball system, which is an instrumentation system which brings into play mobile parts constituted by trains of steel balls containing 1.5% of a sensitive isotope such as vanadium and which circulate, being moved by compressed nitrogen, in tubes, and which penetrate into the vessel via the cover. The neutron flux measurement is based on the activation of the balls when they are placed in a neutron flux; the counting of the activity of the latter takes place by means of fixed detectors placed on racks situated outside the vessel, but in the reactor building. Mention may also be made of the collectron type system, signifying the collection of electrons, which obeys the following physical principles: placed in a neutron flux, a body can emit electrons. The originality of a collectron lies in the fact that, with extremely reduced dimensions, the current supplied is as high, and that the emitted electrons are collected and measured in a continuous process without external polarisation voltage.

The data resulting from the power distribution calculation, a theoretical calculation, generally correspond to a power distribution calculated on the basis of a model reproducing the operational conditions observed during the creation of the flux map. This calculation is carried out in a design office. It observes the following principles:

The signal resulting from the measurement by the fission detectors is proportional to a fission rate in the sensitive part of the detector, i.e. to the product between the effective fission cross-section and the flux. It is therefore necessary to calculate the effective fission cross-section in order to be able to arrive at the activation rate of the detector. The theoretical models employed represent explicitly the glove finger and the instrumentation tube, in order to approach the exact conditions of the measurements in the best possible way. The effective fission cross-section is calculated by taking account of the local conditions around the instrumentation tube and by representing explicitly the glove finger and the instrumentation tube for the calculation of the flux. This calculation is made for each instrumented assembly by a cell code, for example the code known to the person skilled in the art by the name APOLLO 2F. The flux distribution is then calculated by a diffusion code, for example the code known by the person skilled in the art by the name “SMART three-dimensional nodal code”. The data calculated are then as follows:
the 3D distribution of the mean powers per assembly. This power distribution PM CAL (x, y, z) comes into play in the transposition phase;
the total of the rod maximum powers integrated over the active height of the core. For each assembly, only a single rod is taken, that which carries the highest integrated power. This total denoted P CAL DH (x, y) is used in a so-called superposition phase which permits the calculation of the enthalpy rise factor of the core, denoted FDH;
the total of the local maximum powers. For each plane situated in the z dimension and for each assembly, only a single rod is taken, that which carries the maximum local power. This total denoted P CAL (x, y, z) comes into play in the superposition phase in the calculation of the hot spot factors of the cores FQ, FXY (z).

For its part, the process of reconstruction of the measured power distribution chiefly involves three terms.

The first term is the fission reaction rate in the detector also referred to as activity.

The second term involves the ratio between the mean power of an instrumented assembly and the activity experienced by a detector circulating in the glove finger of this assembly. As already stated, it is not the power, but the activity that is measured; it is therefore necessary to have a method which makes it possible to pass from the activity to the power, a method whose general principles are given below: the reaction of neutron absorption by the sensitive matter of the detector takes place in a characteristic energy band of the latter. The knowledge of the quantity of neutrons belonging to this energy band compared to the total number of neutrons is a neutron spectrum problem. The power/activity ratio is a parameter resulting from core calculations carried out in 3D for all the assemblies. These calculations take account both of local spectral effects through the neutron counter-reaction system and the flux distribution. These ratios are updated as a function of the depletion of the fuel to take account of the trend in the isotopic concentrations inside the assembly. In this connection, an assumption is made, which consists in stating that the ratios between calculated values and values reconstructed on the basis of experimental acquisitions are equal for the two variables, activity and power.

The third term is called the fine structure term; it permits one to proceed from the mean power of an assembly to the power of any rod of this assembly. In order to do this, it is assumed that, for a given assembly, the ratio between the power of a rod and the mean power of the assembly to which this rod belongs is independent of the origin of this power, reconstructed or calculated. Moreover, a correction will be applied as a function of calculation/measurement deviations observed around the assembly. This correction leads to the performance of a plane-type two-dimensional linear interpolation. The interpolation is carried out for each assembly and at each z dimension.

Moreover, in order to calculate the reconstructed power at all the non-instrumented points of the reactor, a method permits the calculation/measurement deviations to be estimated at points of the core other than those which have actually been the object of measurements. This is the purpose of the error propagation method described in the following paragraphs.

The error propagation method, which is explained below, starts with an operation which consists first in calculating the deviations between the values actually measured and the values calculated for each assembly instrumented by the instrumentation system. Taking account of the existence of the theoretical calculation and the previously described measurement method, there is known, for each of the instrumented assemblies, both the value of the activity measured by the detectors and the corresponding value calculated under conditions as close as possible to the experimental conditions, and this being on each of the axial sections and.

The performance of the error propagation method, in broad outline, is as follows: its aim is to determine, for each plane of dimension z, a surface Sz which is selected from degree 3 in (x, y) for the complete maps, capable of representing the distribution of the deviations between the calculated activities and the measured activities over the whole core. It will be noted that the choice of this degree depends on the density of the available instrumentation. This method is referred to by the expression “error propagation method SFG (Generalised Surfaces)”.

As stated previously, it is possible to calculate the deviation between the measured activity and the theoretical activity at each instrumented position. It is then assumed that the distribution (x, y) of the deviations in dimension z between the theoretical activity and the measured activity for all the assemblies can be approached by a surface Sz (x, y), being expressed analytically by a two-dimensional polynomial of degree k, fixed by choice at the value 3 for the complete maps. The coefficients of the polynomial characterising this response surface are determined by minimising an error function F with several variables, each of which is one of the coefficients of the polynomial. The method of minimisation is a conventional method of least error squares carried out at each axial dimension and reducing to a minimum the difference between the deviations previously obtained and the deviations calculated with the aid of the polynomial on all the instrumented assemblies.

In practice, for the RIC system, the extension method thus employs a conventional method of minimising deviations, over the 60 instrumented positions and for each axial dimension, between the initial C/M deviation and the value given by the response surface. One thus has an analytical function in (x, y, z) which makes it possible to calculate the calculation/measurement deviations at all the positions of the reactor core. These deviations are then used to correct the theoretical values at all points. After standardisation over the whole of the core, a power distribution reconstructed over the whole volume of the reactor is obtained. Finally, it all takes place as though the calculation were being forced to best approach 60 measurement points, the reconstructed power distribution being nothing other than the power distribution resulting from this forcing.

### TECHNOLOGICAL BACKGROUND TO THE INVENTION

Consequently, the error propagation method is associated with a particular uncertainty component, denoted R_{U2}^{N}, which enters into the calculation of an overall uncertainty entering into a total balance-sheet of margins to be considered over the whole of the nuclear reactor in question.

Total uncertainty E_{U}^{N} is generally defined by the following relation, corresponding to a conventional quadratic reassembly:

E_{U}^{N}=\sqrt{(μ_{U}^{N})²+(R_{U1}^{N})²+(R_{U2}^{N})²+(M_{U}^{N})²} (Relation 1)

The various components entering into relation 1 are the following:
the local 3D rod power distribution in each assembly can only be deduced from the theoretical model simulating the experimental conditions. Uncertainty calculation μ_{U}^{N} over this fine structure is therefore the first component;
since the response of the detectors is not, as has been stated previously, of the power type, but of the reaction rate or activity type, it has to be assumed that the calculation/measurement, deviations of the activity type can be transposed to the power parameter. Uncertainty component R_{U1}^{N} is associated with this transposition assumption;
the calculation/measurement deviations observed in the partial geometrical region covered by the detectors are propagated at every point of the core: uncertainty component R_{U2}^{N}, the so-called error propagation uncertainty component, is associated with the corresponding algorithm;
the latter component characterises the detector, or the combination of detectors, from the physical aspect of the signal and from that of the whole of the acquisition process. These different aspects are thus covered by uncertainty component M_{U}^{N}.

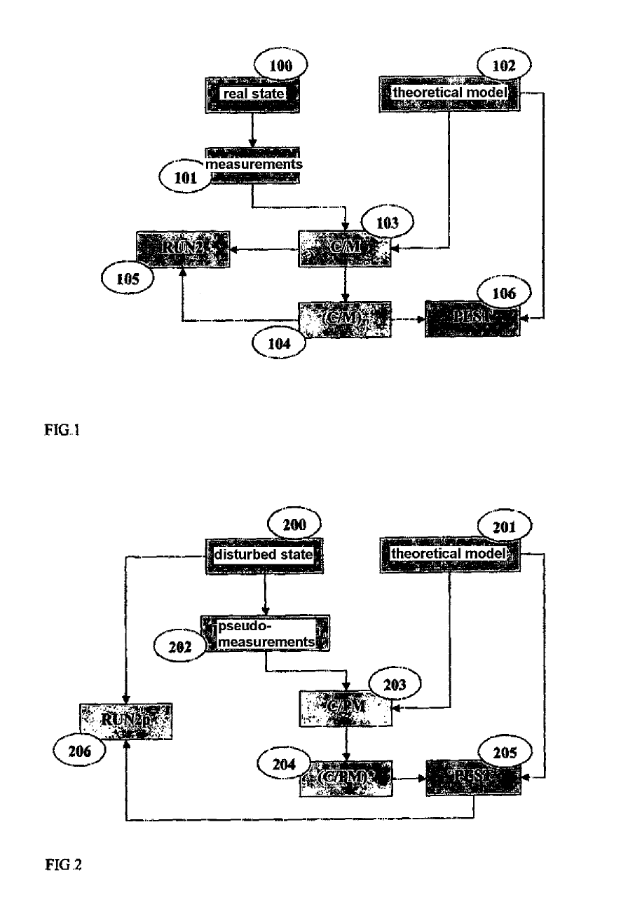

The method of calculating the error propagation uncertainty component, as employed in the prior art, is illustrated schematically by reference to FIG. 1.

In this figure, it is illustrated that, for such a calculation, an actual state 100 is proceeded from, which by definition presents a power distribution which is not known, and which is to be determined. As has been explained previously, a set of measurements 101 is carried out, sixty in the case of the RIC system, on the whole of the reactor core. In parallel, as has also already been explained, use is made of a theoretical model 102 of power distribution prepared in a design office, which gives a complete map of the power distributions inside the nuclear core.

A step 103 is then proceeded to, during which the deviations, or differences, denoted C/M, between the actually measured values and the values predicted by the theoretical calculation are calculated, and this is done for all points of the reactor for which a measurement is available.

According to the previously mentioned error propagation method, in a step 104, deviations denoted (C/M)* are then determined for all points of the nuclear reactor on the basis of the deviations obtained. A generalised or extended deviation is thus obtained, resulting from the error propagation method, which deviation is to be applied to each calculated activity value in order to obtain an estimated activity value for each point of the nuclear reactor.

For its part, the extension uncertainty component (R_{U2}^{N}₂) is calculated directly, in a step 105, from the residues which are constituted, for each point having been the object of an experimental measurement, by the difference between the extended deviation (C/M)* and the initial C/M deviation corresponding to this point, for example by taking the root mean square of these residues.

Finally, in a step 106, following the activity/power transposition step referred to previously, an estimated power Pₑₛₜ is determined at every point of the nuclear reactor core, value Pₑₛₜ being specific to each point of the reactor core.

The solution for the determination of the error propagation uncertainty component (R_{U2}^{N}), which has just being described in detail, is applicable to any nuclear reactor core for which measurements can effectively be carried out, in particular by the RIC system. But such a solution is not applicable to nuclear reactor cores which have just been installed, for which no flux distribution measurement has yet been carried out, and also for existing nuclear reactor cores, but for which it is contemplated to install a new instrumentation system.

Such changes are now appearing. Data processing advances in recent years have in fact permitted the generalisation of 3D core calculation models not only in the design office, but also on-line, these models then being supplied in real time with the operational parameters of the section in question. The technological trends linked to sensors have also made it possible for signals delivered by detectors placed at fixed positions in the core to be permanently available.

New instrumentation systems, the purpose of which is the on-line monitoring of operational margins, can thus be defined. However, the corresponding uncertainties associated with these new systems must obviously be subjected to an evaluation before industrial installation, i.e. in the absence of any operation feedback about these systems.

It is in this context that the method according to the invention is of interest: the present invention essentially relates to the determination of error propagation uncertainty component R_{U2}^{N} for nuclear reactors for which a new instrumentation system is capable of being used. In such a case, a major problem arises for the determination of uncertainty component R_{U2}^{N}: due to the newness of the measurement, system that is to be installed, there are no operational measurements for determining this uncertainty component.

### GENERAL DESCRIPTION OF THE INVENTION

The present invention provides a solution to the problem which has just been described. In the invention, a method is proposed which makes it possible to obtain an error propagation uncertainty component for any nuclear reactor, even those intended to be provided with a measurement instrumentation system for which there is no operation feedback concerning the system in question. For this purpose, it is proposed in the invention to use data originating from experience feedback acquired with a reference instrumentation system, for example the RIC system. This available experience feedback is then used to apply disturbances to a theoretical power distribution model, the spatial amplitude and distribution of said disturbances being such that the deviations observed between the disturbed theoretical model and the theoretical model directly resulting from the calculation are representative of those observed in reality.

Thus, the problem posed by this absence of operation feedback with a new measurement system can be overcome by means of considerable experience feedback already acquired with a reference instrumentation. Since this experience feedback essentially takes the form of a 3D calculation/measurement deviations base, it is thus proposed in the invention to apply to the theoretical models disturbances whose amplitude and distribution will be such that the 3D deviations, denoted calculation/pseudo-measurement deviations as will be explained in detail below, in relation to the initial models, are representative of those actually present in the core of the nuclear reactor on which the method according to the invention is used.

Thus, for example, for nuclear reactor cores intended to be provided with measurement systems of the collection type, for which experience feedback having the characteristics required for the envisaged application can be considered as insufficient, a disturbed theoretical model will be established on the basis of measurements carried out by means of RTC systems, which have the advantage of offering very considerable experience feedback, permitting the disturbances to be applied to a purely theoretical model to be defined with precision.

The invention thus essentially relates to a method for determining the uncertainty component, a so-called error propagation uncertainty component, entering into the calculation of an overall uncertainty associated with a power distribution of a nuclear reactor core. This method is characterised in that it comprises different steps consisting in:
establishing a three-dimensional map of a theoretical power distribution of the nuclear reactor core in question; to advantage, three-dimensional theoretical power distribution maps are available for various configurations of the nuclear reactor core.
establishing a disturbed representation of the nuclear reactor core, the disturbed representation consisting in applying at least one physical disturbance parameter to the theoretical power distribution for at least a plurality of points of the nuclear reactor core, the applied physical disturbance parameter assuming a value resulting from measurements carried out on nuclear reactor cores of comparable design;
selecting a set of activity values or reaction rates, referred to as pseudo-measurements, in the disturbed representation of the nuclear reactor core;
determining, for each point of the nuclear reactor associated with a psuedo-measurement, an initial deviation between a theoretical activity, resulting from the theoretical three-dimensional map of the nuclear reactor core, and the pseudo-measurement, deduced from the disturbed model, associated with the point in question;
performing, on the basis of the determined initial deviations, an operation of the error propagation method on the whole of the reactor core in order to associate an extended correction value with each point of the nuclear reactor core;
determining, for each point of the nuclear reactor, an estimated power, the extended correction value entering as a parameter in said determination of an estimated power;
calculating a plurality of residues by working out the difference, for this same plurality of points of the nuclear reactor core, between in the estimated power and the disturbed representation of this power for each point in question;
determining the error propagation uncertainty component on the basis of the residues thus evaluated.

The expression “point of the nuclear reactor core” is intended to denote a volume of the nuclear reactor for which it is sought to attribute, in the context of preparing a 3D power distribution, a power value, or a physical parameter value correlated with the power. Each point of the nuclear reactor core is thus associated with one unique such value. The method according to the invention thus comprises in particular a measurement step permitting the values of the physical disturbance parameters to be obtained that are to be applied to the theoretical power distribution.

Apart from the main features which have just been mentioned in the previous paragraph, the method according to the invention can have one or more additional features among the following:
the physical disturbance parameters are among the following parameters:
misalignment of at least one control cluster with respect to the other control clusters of the nuclear reactor core in question;
lack of precision of the position of the control clusters;
lack of precision of the admission temperature of the moderator; the term “moderator” denotes, in a general manner, a material formed by light nuclei which decelerate the neutrons. It should have only a slight capturing capacity in order not to waste the neutrons and it should be sufficiently dense in order to ensure effective retardation.
inhomogeneity of the boron concentration in the moderator;
inhomogeneity of the irradiation of the fuel assemblies;
lack of precision of the nominal power of the reactor core;
disequilibrium, azimuthal or radial, in the distribution of the nuclear power between quadrants of the reactor core.
the step for determining the estimated power complies with the following equation, involving for each point in question the value of the theoretical power Pcal: Pest=Pcal/(1+(C/PM)*), where (C/PM)* represents the extended correction value;
the selected pseudo-measurements are so selected for points of the reactor core where a measurement instrumentation is intended to be installed;
the plurality of residues is calculated for all of points of the nuclear reactor core;
the error propagation method performed to associate an extended correction value with each point of the nuclear reactor core is of the SFG extension method type of degree three or two according to the density of the instrumentation; and the SFG propagation mode is an external mode, the main advantages of which are simplicity and robustness. In other examples of implementation, another propagation mode is selected, in particular a mode where the calculation/measurement deviations correct parameters inside the internal loops of the neutron calculation; the parameters to be modified, therefore, can for example be the effective cross-sections, the local densities, . . . ;
the measurements previously carried out have been obtained with a system of the RIC type.

The expression “nuclear reactor core of comparable design” is intended to mean nuclear reactor cores whose architecture, in particular in terms of general disposition of fuel assemblies, has significant elements of similarity with that of the nuclear reactor core on which the method according to the invention is applied. Thus, the method can be applied without distinction to 2-loop (121 assemblies), 3-loop (157 assemblies), 4-loop (193 assemblies), 4-loop N4 (205 assemblies) and EPR (241 assemblies) cores. The ratio between the number of instrumented assemblies and the total number of assemblies for reactor cores other than those of the EPR is close to 30% (30/121=0.25, 50/157=0.32, 58/193=0.30 and 60/205=0.29). In the case of EPR, this ratio is 40/241=0.17. The method according to the invention is especially used, with the same instrumentation, to quantify the impact of the significant reduction in this ratio on the extension factor. This quantification has thus been carried out for the transition from 58 instrumented channels to 42 (in the context of a complementary RIC scheme resulting from the introduction of 16 collectron rods into guide tubes which were normally monitored by mobile probes: 42/193=0.22 et 42/58=0.72), and from 58 to (in the context of the previously mentioned collectron scheme).

The invention and its various applications will be better understood from a reading of the following description and an examination of the accompanying figures.

### BRIEF DESCRIPTION OF THE FIGURES

These are presented merely by way of a guide and on no account limit the invention. The figures show:
in FIG. 1, already described, a schematic representation of the various steps of a method of the prior art illustrating the method of extension of the C/M deviations observed in a nuclear reactor core;
in FIG. 2, a schematic representation of the various steps of an example of the implementation of the C/M error propagation method according to the invention and thus of the extension at every point of the core of the C/M deviations observed in a partial region in a nuclear reactor core.

### DETAILED DESCRIPTION OF PREFERRED EMBODIMENTS OF THE INVENTION

FIG. 2 illustrates schematically an example of the implementation of the method according to the invention for calculating the error propagation uncertainty component. In order to show the difference between the methods of the prior art and the method according to the invention in the determination of this uncertainty component, the latter, when it results from the method according to the invention, is denoted R_{U2p}^{N}.

In this figure, it is illustrated that, in the method according to the invention, a so-called disturbed state 200 is proceeding from, which corresponds to a theoretical power disturbance model 201, to which at least one physical disturbance parameter has been applied at each point of the nuclear reactor core. In a particular mode of implementation of the method according to the invention, it is the totality of the points of the nuclear reactor core to which such a disturbance is applied.

For example, the physical disturbance to be applied corresponds to one or more physical parameters among the following:
misalignment of at least one control cluster with respect to the other control clusters of the nuclear reactor core in question;
lack of precision of the position of the control clusters; these first two physical parameters are linked to the fact that the control clusters, which are conventionally introduced via the top of the reactor core, and which are intended to control the power of the reactor core—or even to shut down the latter completely in the event of a serious malfunction—are moved by complex mechanical systems, the precision of the displacements, and a fortiori relative displacements, of these control clusters
lack of precision of the admission temperature of the moderator;
inhomogeneity of the boron concentration;
inhomogeneity of the irradiation of the fuel assemblies;
lack of precision of the nominal power of the reactor core;
disequilibrium, azimuthal or radial, in the distribution of the nuclear power between quadrants of the reactor core.

To advantage, the values of the applied disturbances come from a data base resulting from experimental data obtained on nuclear reactor cores exhibiting similarities with the reactor core upon which the method according to the invention is applied. The similarities presented essentially relate to the spatial organisation of the fuel assemblies inside the reactor core, with for example similarities in the observed distribution symmetries. On the other hand, it is not indispensable for the nuclear reactor core upon which the method according to the invention is applied to have the same type of measurement instrumentation. It is thus possible to use experimental results collected by means of an RIC system to determine the disturbances to be applied to the points of a nuclear reactor core which is to be provided with a measurement instrumentation system of a different type, for example of the aeroball or collectron type.

In the illustrated method according to the invention, in a step 202, a set of values of activities or reaction rates, referred to as pseudo-measurements, are selected in the values defining the disturbed state of the nuclear reactor core; then, in a step 203, an initial deviation, denoted (C/PM), between the theoretical reaction rate and the corresponding pseudo-measurement is determined for each point of the nuclear reactor associated with a selected pseudo-measurement.

In a step 204, on the basis of the determined initial deviations, an operation of the error propagation method is then carried out for the whole of the reactor core in order to associate an extended correction value, denoted (C/PM)*, with each point of the nuclear reactor core

In a step 205, an estimated power is then determined for each point of the nuclear reactor, the value of the extended correction entering as a parameter in said determination of the estimated power.

According to the method of the invention, it is then possible, in a step 206, to calculate a plurality of residues by working out the difference, for at least a plurality of points of the nuclear reactor core, between the estimated power and the disturbed representation of this power for each point, in question; error propagation uncertainty component R_{U2p}^{N} is then established on the basis of the evaluated residues, for example by working out their root mean square value. To advantage, the residues are calculated for all points of the nuclear reactor.

Thus, relation 1, which defines the final reassembly of reconstruction uncertainty E_{U}^{N} resulting from a process of being applying to the triplet (actual configuration of the core, simulated theoretical configuration, C/M deviations), is then replaced by an equation 2, defining the same reassembly on the basis of a new triplet (disturbed theoretical configuration, initial theoretical configuration, C/PM deviations)

Relation 1 then becomes:

E_{Up}^{N}=\sqrt{(μ_{U}^{N})²+(R_{U1}^{N})²+(R_{U2p}^{N})²+(M_{Up}^{N})²} Equation 2

Index P of this relation is of primary importance: it essentially concerns making a clear distinction with the triplets which are upstream of the final reassembly.

The term (E_{Up}^{N}) of relation 2 has the same significance as the uncertainty (E_{U}^{N}) of relation 1. It thus consists of the same terms. The two factors which are assigned to the first order by a change of instrumentation system are obviously the component (M_{U}^{N}) characterising the detector used and the component (R_{U2}^{N}) covering the transition from experimental data over a partial region to the maximum local 3D power at every point of the core.

The component (R_{U2}^{N}) will always be affected by a change of instrumentation system. Its conventional evaluation is based on a comparison between the extended deviation (C/M)*, via the adopted error propagation algorithm, at a point monitored by the instrumentation available, and the initial C/M deviation at an actually instrumented point. This comparison thus involves the existence of an experimental reference, this reference being partial in all cases.

In order to reduce this partial character, the method according to the invention allows this comparison to be made on a complete whole. Component R_{U2p}^{N} is now evaluated by comparison of the local 3D power distributions reconstructed at every point of the core and equivalent reference distributions determined within the scope of the method according to the invention.

Additionally, it can be stated that, in order that the distributions of C/PM deviations are representative of C/M deviations actually observed during the monitoring of the functioning reactors, it is necessary that the types and the amplitude of the disturbances applied to the generic models have been correctly defined.

This definition takes place by the construction of a real reference base covering the configuration maximum from the dual standpoint of the types of assemblies loaded in the operational reactors and the method of management of the time spent by these assemblies in the reactor.

The definition of the sets of pseudo-measurements is one of the objectives assigned to the reference models. It is therefore essential that these sets are as close as possible to those actually observed on site for each of the instrumentation systems analysed.

It is therefore necessary to take account at the same time of all the characteristics of these systems and the impact of these characteristics with respect to the response of the RIC reference system. These impacts are associated:
a) with the change in the radial density of the instrumented channels (58→42 channels for the complementary RIC schemes of a conventional 4-loop core and 58→16 for collectron schemes of cores of this type);
b) with the type of detector (uranium 235 in the case of the RIC and rhodium 103 in the case of the collectrons);
c) with the change in the axial distribution of the measurement points in the case of detectors of the collectron type (65 continuous axial sections→8 discontinuous axial sections), hence the need for an axial-section conversion;
d) with the characteristics of experimental uncertainty M_{U}^{N}.
   In the case of signals of the RIC type, this uncertainty comprises only a local 3D part independent of time
   In the case of collectrons, it is important to take account of the 3D and 2D components (per rod) of this uncertainty and of its variability in the course of wear.

In order on the one hand to minimise the number of disturbed configurations to be constructed and on the other hand to consolidate further the link with the real experimental base, it has been chosen, for the first practical applications for the implementation of the method according to the invention, to use a differential approach with respect to the reference instrumentation.

The internal instrumentation of the CFM (mobile fission chamber) type is in fact considered as a reference instrumentation by reason:
1. of its axial resolution (1 acquisition/mm);
2. of its self-calibration (a plurality of detectors can monitor the same channel);
3. of its precision independent of time (negligible wear, because the detectors are only irradiated for approx. 1 hour each month);
4. of an almost complete cover per quadrant in the case of present 3-loop and 4-loop cores;
5. of a final uncertainty (E_{U}^{N}) which is well controlled and reliant on a considerable experimental base.

The reassembly is thus carried out according to the following relation:

(E_{U}^{N})_{SchX}=(E_{U}^{N})_{REF}+(ΔE_{Up}^{N})_{SchX}^{REF} Relation 2a

The term SchX refers to the expression “scheme X”, being applied to any instrumentation system different from the reference instrumentation system (denoted by the term REF). The corrective term (ΔE_{U2p}^{N})_{SchX}^{REF} of relation 2a defining this differential reassembly can thus be applied with:

(E_{Up}^{N})_{REF}=\sqrt{(μ_{U}^{N})²+(R_{U1}^{N})_{REF}²+(R_{U2p}^{N})_{REF}²+(M_{U}^{N})_{REF}²} (relation 3)

and

(E_{Up}^{N})_{SchX}=\sqrt{(μ_{U}^{N})²+(R_{U1}^{N})_{SchX}²+(R_{U2p}^{N})_{SchX}²+(M_{U}^{N})_{SchX}²} (relation 4)

This corrective term contains not only the difference (ΔR_{U2p}^{N})_{SchX}^{REF}, but also those that result from a change of detector or a combination of detectors, hence for example the variations (ΔR_{U1}^{N})_{SchX}^{REF}, (ΔM_{U}^{N})_{SchX}^{REF} and/or (ΔX_{U}^{N})_{SchX}^{REF}, X denoting an uncertainty factor existing only for configuration SchX.

From the standpoint of the reconstructed power distributions, component R_{U2p}^{N} remains the characteristic indicator of any instrumentation system. The difference (ΔR_{U2p}^{N})_{SchX}^{REF} is therefore the determining parameter in the dimensioning of uncertainty E_{U}^{N} and it has been analysed for all the configurations of the disturbances base.

The variability observed in the difference (ΔR_{U2p}^{N})_{SchX}^{REF} is in large measure a consequence of factor M_{U}^{N} via the 3D noise process of the pseudo-measurements. In practice, this difference is defined upstream of the final reassembly by using a statistical approach.

To advantage, provision is made in the invention, once real measurements obtained by means of a new measurement system are available, to compare the results obtained by the method according to the invention for determining the error propagation uncertainty component and the results obtained according to conventional methods for determining uncertainty components, on the basis of the real measurements obtained. It is thus verified that the uncertainty evaluated by the method according to the invention is not put into question.

1. A method for determining an uncertainty component (R_{U2p}^{N}), a so-called error propagation uncertainty component, entering into the calculation of an overall uncertainty (E_{Up}^{N}) associated with a power distribution of a nuclear reactor core, characterised in that it comprises different steps consisting in:
establishing (201) a three-dimensional map of a theoretical power distribution of the nuclear reactor core in question;
establishing (200) a disturbed representation of the nuclear reactor core, the disturbed representation consisting in applying at least one physical disturbance parameter to the theoretical power distribution for at least a plurality of points of the nuclear reactor core, the applied physical disturbance parameter assuming a value resulting from measurements carried out for nuclear reactor cores of comparable design;
selecting (202) a set of activity values or reaction rates, referred to as pseudo-measurements, in the disturbed representation of the nuclear reactor core;
determining (203), for each point of the nuclear reactor associated with a psuedo-measurement, an initial deviation between a theoretical activity, resulting from the theoretical three-dimensional map of the nuclear reactor core, and the pseudo-measurement, associated with the point in question;
performing (204), on the basis of the determined initial deviations, an operation of the error propagation method on the whole of the reactor core in order to associate an extended correction value with each point of the nuclear reactor core;
determining (205), for each point of the nuclear reactor, an estimated power, the extended correction value entering as a parameter in said determination of an estimated power;
calculating a plurality of residues by working out the difference, for this same plurality of points of the nuclear reactor core, between the estimated power and the disturbed representation of this power for each point in question;
determining (206) the error propagation uncertainty component on the basis of the residues calculated.

2. The method according to claim 1, wherein the physical disturbance parameters are among the following parameters:
misalignment of at least one control cluster with respect to the other control clusters of the nuclear reactor core in question;
lack of precision of the position of the control clusters;
lack of precision of the admission temperature of the moderator;
inhomogeneity of the boron concentration;
inhomogeneity of the irradiation of the fuel assemblies;
lack of precision of the nominal power of the reactor core;
disequilibrium, azimuthal or radial, in the distribution of the nuclear power between quadrants of the reactor core.

3. The method according to claim 1, wherein the step for determining the estimated power complies with the following equation, involving for each point in question the value of the theoretical power Peal: Pest=Pcal/(1+(C/PM)*), where (C/PM)* represents the extended correction value.

4. The method according to claim 1, wherein the selected pseudo-measurements are so selected for points of the reactor core where a measurement instrumentation is intended to be installed.

5. The method according to claim 1, wherein the residues are calculated for all points of the nuclear reactor core.

6. The method according to claim 1, wherein the error propagation method performed to associate an extended correction value with each point of the nuclear reactor core is of the SFG extension method type of degree three or two according to the density of the instrumentation.

7. The method according to claim 1, wherein the measurements previously carried out have been obtained with an instrumentation system of the RIC type.

8. The method according to claim 2, wherein the step for determining the estimated power complies with the following equation, involving for each point in question the value of the theoretical power Peal: Pest=Pcal/(1+(C/PM)*), where (C/PM)* represents the extended correction value.

9. The method according claim 2, wherein the selected pseudo-measurements are so selected for points of the reactor core where a measurement instrumentation is intended to be installed.

10. The method according claim 3, wherein the selected pseudo-measurements are so selected for points of the reactor core where a measurement instrumentation is intended to be installed.

11. The method according to claim 2, wherein the residues are calculated for all points of the nuclear reactor core.

12. The method according to claim 3, wherein the residues are calculated for all points of the nuclear reactor core.

13. The method according to claim 4, wherein the residues are calculated for all points of the nuclear reactor core.

14. The method according to claim 2, wherein the error propagation method performed to associate an extended correction value with each point of the nuclear reactor core is of the SFG extension method type of degree three or two according to the density of the instrumentation.

15. The method according to claim 3, wherein the error propagation method performed to associate an extended correction value with each point of the nuclear reactor core is of the SF G extension method type of degree three or two according to the density of the instrumentation.

16. The method according to claim 4, wherein the error propagation method performed to associate an extended correction value with each point of the nuclear reactor core is of the SF G extension method type of degree three or two according to the density of the instrumentation.

17. The method according to claim 5, wherein the error propagation method performed to associate an extended correction value with each point of the nuclear reactor core is of the SFG extension method type of degree three or two according to the density of the instrumentation.

18. The method according to claim 2, wherein the measurements previously carried out have been obtained with an instrumentation system of the RIC type.

19. The method according to claim 3, wherein the measurements previously carried out have been obtained with an instrumentation system of the RIC type.

20. The method according to claim 4, wherein the measurements previously carried out have been obtained with an instrumentation system of the RIC type.
